(19) United States
(12) Patent Application Publication
(10) Pub. No.: US 2019/0057448 A1
(43) Pub. Date: Feb. 21, 2019

(54) SYSTEMS AND METHODS FOR DETERMINING AN INDEX VALUE AND/OR A NET ASSET VALUE OF ONE OR MORE COMPONENTS OF A FUND

(71) Applicant: Metaurus, LLC, New York, NY (US)

(72) Inventor: Richard P. Sandulli, Kamuela, HI (US)

(21) Appl. No.: 15/898,570

(22) Filed: Feb. 17, 2018

Related U.S. Application Data
(60) Provisional application No. 62/460,766, filed on Feb. 18, 2017.

(51) Int. Cl. G06Q 40/06

(52) U.S. Cl. CPC G06Q 40/06

(57) ABSTRACT

Systems and methods for determining an index value or the net asset value of one or more components of a fund. Methods of calculating an index value and/or a NAV of a component of a fund, the index having a predetermined index duration including the steps of: separating the index duration into at least one time period; retrieving at least one first asset price, each of the at least one first asset price associated with one of the underlying reference assets and one of the at least one time period; retrieving at least one second asset price, each of the at least one second asset price associated with one of the at least one time period; determining at least one discount factor, each of the at least one discount factor determined from a characteristic of one of the at least one second asset; determining at least one first component net asset value portion, each of the at least one first component net asset value portion associated with one of the at least one time period, each of the at least one first component net asset value portion determined from the at least one first asset price and the at least one discount factor associated with the at least one time period of the at least one first component net asset value portion; and determining the first component net asset value as one of the group consisting of: the at least one first component net asset value portion and a sum of the at least one first component net asset value portion.

### COPYRIGHT NOTICE

A portion of the disclosure of this patent document contains material which is or may be subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### CROSS-REFERENCE TO RELATED APPLICATIONS

This application claims the benefit of the U.S. provisional patent application entitled “Systems and Methods for Determining an Index Value and/or a Net Asset Value of One or More Components of a Fund”, having Ser. No. 62/460,766, filed Feb. 18, 2017, which is hereby incorporated by reference in its entirety as if fully set forth herein.

### BACKGROUND OF THE INVENTION

Embodiments of the present invention generally relate to systems and methods for determining an index value and/or the net asset value of one or more components of a fund. Specifically, embodiments of the present invention generally relate to systems and methods for determining an index value or the net asset value of one or more components of a fund, wherein the fund may include at least one separately tradable asset component or any other separately valuable component.

### BRIEF SUMMARY OF THE INVENTION

Briefly stated, in one aspect of the present invention, systems and methods for determining an index value and/or the net asset value of one or more components of a fund is provided.

In one aspect of the present invention, a method of calculating an index value and/or a NAV of a component of a fund, wherein the index has a predetermined index duration, is provided. This method includes the steps of: separating the index duration into at least one time period; retrieving at least one first asset price, each of the at least one first asset price associated with one of the underlying reference assets and one of the at least one time period; retrieving at least one second asset price, each of the at least one second asset price associated with one of the at least one time period; determining at least one discount factor, each of the at least one discount factor determined from a characteristic of one of the at least one second asset; determining at least one first component net asset value portion, each of the at least one first component net asset value portion associated with one of the at least one time period, each of the at least one first component net asset value portion determined from the at least one first asset price and the at least one discount factor associated with the at least one time period of the at least one first component net asset value portion; and determining the first component net asset value as one of the group consisting of the at least one first component net asset value portion and a sum of the at least one first component net asset value portion.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIGS. 1A and 1B depict one method of calculating and disseminating an index value and/or a NAV in accordance with one embodiment of the present invention; and

FIG. 2 depicts a schematic view of an exemplary network environment within which various embodiments of the present invention may be implemented;

FIG. 3 depicts a block diagram of an exemplary computing device within which various embodiments of the present invention may be implemented; and

FIG. 4 depicts a table of annual exemplary initial treasury securities corresponding to annual dividend future contracts.

### DETAILED DESCRIPTION OF THE INVENTION

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a method” may include a plurality of methods. Thus, for example, a reference to “a method” may include one or more methods and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

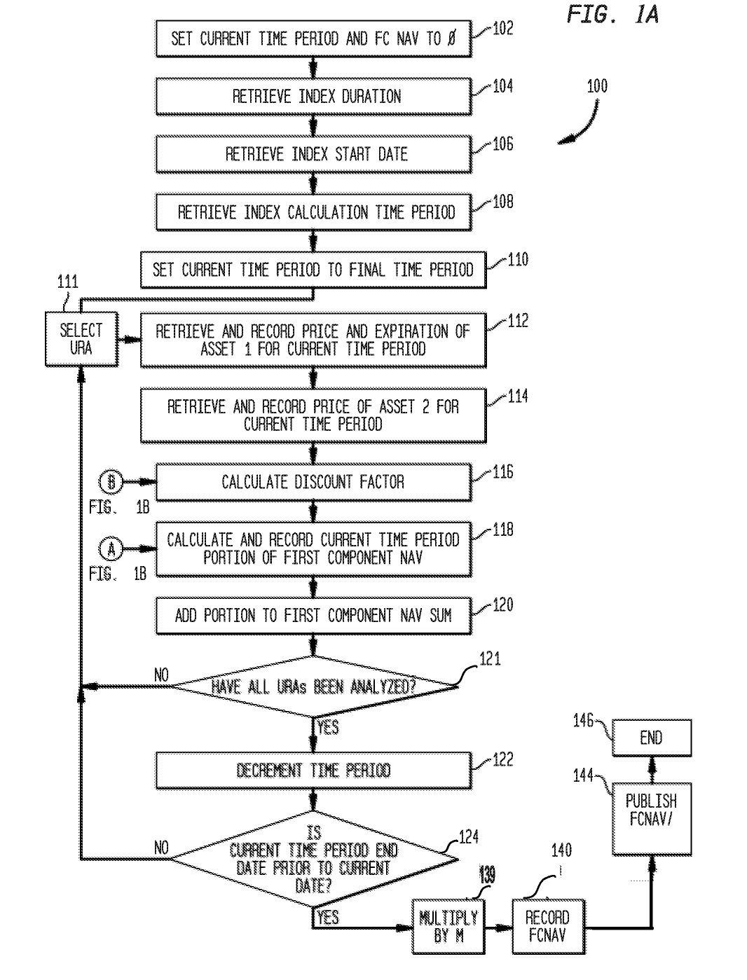

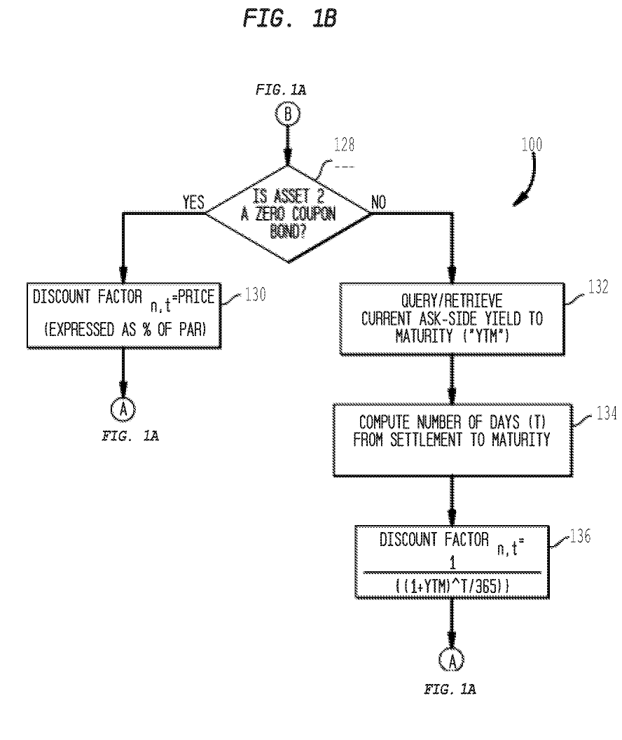

Disclosed herein are systems and methods for determining an index value and/or a net asset value of one or more components of a fund. An example of one such method for determining an index value and/or a net asset value is depicted in FIGS. 1A and 1B. For example, in one embodiment of the invention, the exemplary method shown in FIGS. 1A and 1B may be used to calculate an index. Such an index may be used for informational purposes only. For example, the index may be used for analysis and/or decision making purposes including, but not limited to, investment decision making. In another embodiment, this exemplary method may be additionally or alternatively used to determine the net asset value of shares of a fund such as the exemplary divided futures fund discussed in greater detail herein.

In one embodiment, the fund includes, and/or the index is calculated, based upon assets related to the Standard & Poor's 500® Index (“S&P 500”) such as, for example, S&P 500 Dividend Index Futures Contracts. However, alternate assets or securities may be substituted without departing from the scope hereof.

In the embodiment of the present invention described with reference to FIGS. 1A and 1B, the present invention aims to represent the discounted present value of S&P 500 Dividend Futures Contracts out to and including the dividend futures expiry, which occurs on a predetermined end date. In one method, each S&P 500 Dividend Futures contract price will be discounted by using the computed yield of a specified U.S. Treasury Security with a similar or prior maturity date as the corresponding S&P 500 Dividend Futures Contract expiry as discussed in greater detail below. After expiry of any S&P 500 Dividend Futures Contracts, such futures contract and its corresponding treasury security will be removed from the Index.

In one aspect of the present invention, the index is a price only index that is published in United States dollars (“USD”). However, alternate currencies may be substituted without departing from the scope hereof.

In one embodiment of the invention, the index is associated with a fund or values that are intended to be static in that the composition of the index and/or in a fund that is not expected to change after the index and/or fund is originally constituted. The index may calculate the NAV of the fund shares. In one such exemplary fund, the fund holds the dividend future contracts (e.g., S&P 500 Dividend Futures Contracts) and treasury bonds that form the basis of the index and/or FC NAV calculation. For example, the fund (e.g., an income trust) will be responsible for holding the necessary dividend future contracts and treasury bonds (e.g., STRIPs, coupon treasury bonds, etc.) that form the basis for the calculation of the FCNAV. U.S. Treasury Separate Trading of Registered Interest and Principal of Securities (“STRIPS”) are fixed income securities sold by the U.S. Treasury. In one embodiment, this occurs via a block trade of the necessary contracts and bonds at the close of each trading day (e.g., 4:00 p.m.). That is, all parties to the trade will agree to the trade in advance at a screenshot price occurring exactly at 4:00. These screenshot prices will be the same prices utilized to calculate the FCNAV as described herein. However, alternate embodiments for holding the necessary dividend future contracts and treasury bonds may be substituted without departing from the scope hereof.

Turning now to FIGS. 1A and 1B, a process such as process 100 may be utilized to calculate the NAV of a fund. For example, a fund is envisioned which holds a plurality of assets but allows investors to purchase only the equity or only the dividend component of the assets held in the fund. In such a scenario, a process such as process 100 may be utilized to calculate the first component net asset value (“FC NAV”) (i.e., the cost per share to purchase the dividend component only of the assets). Thereafter, the process may be extended to calculate the second component net asset value (“SC NAV”) (i.e., the cost per share to purchase the equity component only of the assets). For example, in this exemplary embodiment wherein the FC NAV and SC NAV are expressed as a percentage of the par value of the Underlying Reference Assets (“URAs”)(e.g., STRIPs, coupon treasury bonds, etc.), the SCNAV may be calculated by subtracting the value of the FCNAV from one (1). Thereafter, it may be recorded in a database such as ETF database 214.

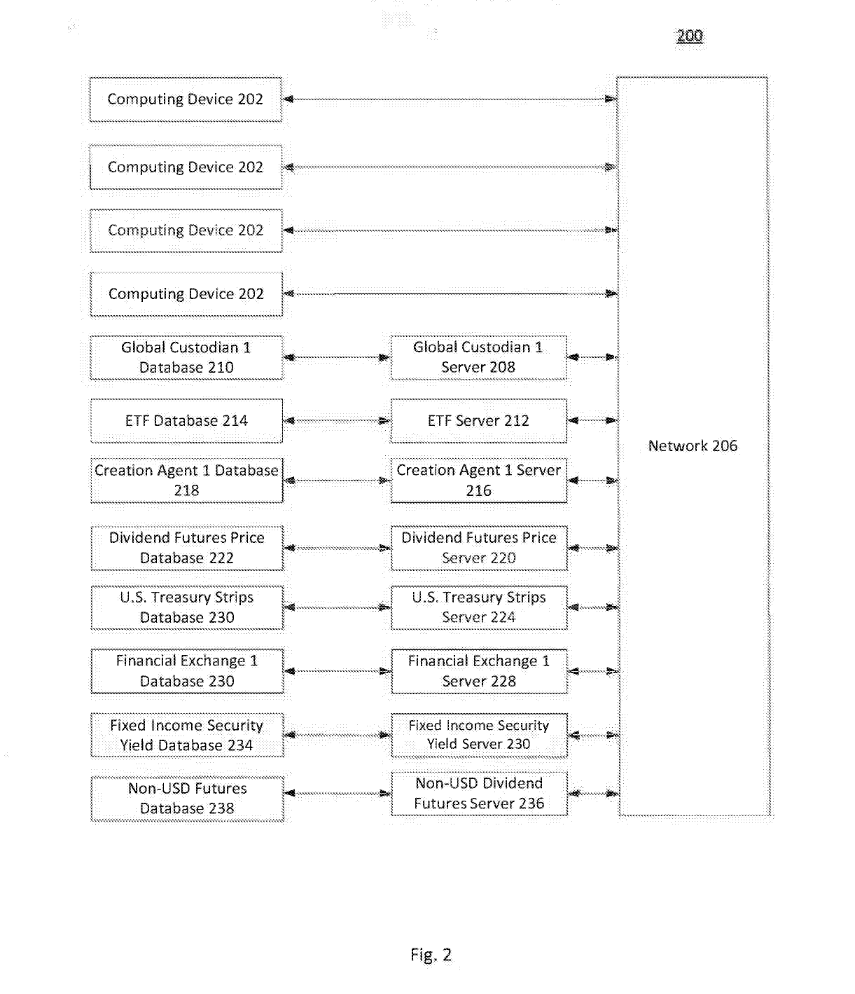

Referring now to FIG. 2, depicted is an exemplary computing system environment for allowing a user of system 200 to perform the methods described herein. The depicted computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal computers (“PCs”), server computers, handheld or laptop devices, multi-processor systems, microprocessor-based systems, network PCs, minicomputers, mainframe computers, cell phones, tablets, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

In the depicted embodiment, exemplary system 200 includes, inter alia, one or more computing devices 202 and a plurality of servers including global custodian server 208, ETF server 212, creation agent server 216, dividend futures price server 220, U.S. Treasury STRIPS server 224, financial exchange server 228, fixed income security yield server 232, and non-USD dividend futures server 236, which interface to each other via network 206. These servers typically include the same components as local computing devices 202, as described in detail below, although one or more components may be omitted without departing from the scope hereof.

Each of the depicted servers also have corresponding databases, namely, global custodian database 210, ETF database 214, creation agent 1 database 218, dividend futures price database 222, U.S. Treasury Strips database 230, Financial Exchange 1 database 230, fixed income security yield database 234, and non-USD futures database 238, respectively. The servers and databases shown in FIG. 2 are merely exemplary and servers and/or databases may be omitted or added without departing from the scope of the present invention. Further, one or more databases may be included in the respective server without departing from the scope hereof.

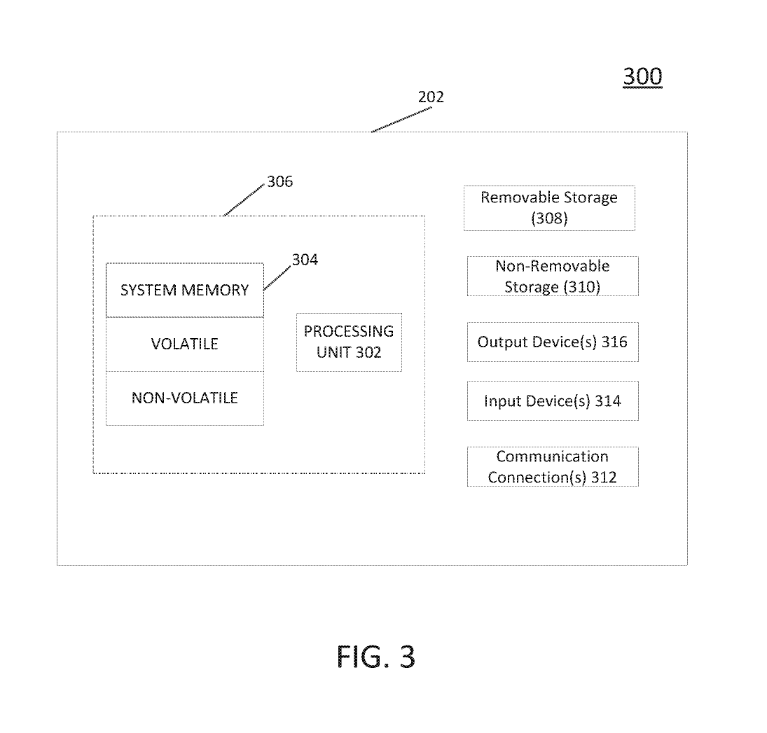

In its most basic configuration, as depicted in FIG. 3, computing device 202, or a server such as server 208, 212, 216, 220, 224, 228, 232, and/or 236, includes at least one processing unit 302 and at least one memory 304. The processing unit and memory may be tangible elements in a computing device. Or, they may be virtualized, for example as elements of a virtual machine hosted in a so-called computing cloud. Depending on the exact configuration and type of the computing device, memory 304 may be volatile (such as random access memory (“RAM”)), non-volatile (such as read-only memory (“ROM”), flash memory, etc.), or some combination of the two. This most basic configuration is illustrated in FIG. 3 by dashed lines 306. In addition to that described herein, computing devices 202 can be any web-enabled handheld device (e.g., cell phone, smart phone, or the like) or personal computer including those operating via Android™, Apple®, and/or Windows® mobile or non-mobile operating systems.

Computing device 202 may have additional features/functionality. For example, computing device 202 may include additional storage (removable and/or non-removable) including, but not limited to, magnetic or optical disks or tape, thumb drives, and external hard drives as applicable. Such additional storage is illustrated in FIG. 3 by removable storage 308 and non-removable storage 310.

Computing device 202 typically includes or is provided with a variety of computer-readable media. Computer-readable media can be any available media that can be accessed by computing device 202 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 304, removable storage 308, and non-removable storage 310 are all examples of computer storage media. Computer storage media includes, but is not limited to, RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, or any other medium which can be used to store the desired information and which can accessed by computing device 202. Any such computer storage media may be part of computing device 202 as applicable.

Computing device 202 may also contain communications connection 312 that allows the device to communicate with other devices. Such communications connection 312 is an example of communication media. Communication media typically embodies computer-readable instructions, data structures, program modules and/or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (“RF”), infrared and other wireless media. The term computer-readable media as used herein includes both storage media and communication media.

Computing device 202 may also have input device(s) 314 such as keyboard, mouse, pen, voice input device, touch input device, etc. Output device(s) 316 such as a display, speakers, printer, etc. may also be included. All these devices are generally known to the relevant public and therefore need not be discussed in any detail herein except as provided.

Notably, referring back to FIG. 2, computing device 202 is one of a plurality of computing devices 202 inter-connected by network 206. As may be appreciated, network 206 may be any appropriate network and each computing device 202 may be connected thereto by way of connection 312 in any appropriate manner, and each computing device 202 may communicate with one or more of the other computing devices 202 via network 206 in any appropriate manner. For example, network 206 may be a wired network, wireless network, or a combination thereof within an organization or home or the like, and may include a direct or indirect coupling to an external network such as the Internet or the like. Likewise, network 206 may be such an external network including, without limitation, the Internet. In the exemplary embodiments shown herein, network 206 is the Internet and allows the multiple systems necessary to implement the systems and methods discussed herein to communicate data quickly and efficiently. However, alternate networks and/or methods of communicating information may be substituted without departing from the scope hereof.

Computing device 202 may connect to the various servers via such an internal or external network. Although FIG. 2 depicts computing device 202 located in close proximity to the servers, this depiction is not intended to define any geographic boundaries. For example, when network 206 is the Internet, computing device can have any physical location. For example, computing device may be a tablet, cell phone, personal computer, or the like located at any user's office, home, etc. Or computing device could be located proximate to one or more servers without departing from the scope hereof. Also, although FIG. 2 depicts computing devices 202 coupled to the servers via network 206, computing devices may be coupled directly to one or more servers via any other compatible networks including, without limitation, an intranet, local area network, or the like.

The depicted embodiment of system 200 uses a standard client server technology architecture, which allows users of system 200 to access information stored in the relational databases via custom user interfaces. In some embodiments of the present invention, the processes are hosted on one or more servers which are accessible via the Internet using a publically addressable Uniform Resource Locator (“URL”). For example, users can access exemplary system 200 using any web-enabled device equipped with a web browser. Communication between software component and sub-systems are achieved by a combination of direct function calls, publish and subscribe mechanisms, stored procedures, and direct SQL queries, however, alternate components, methods, and/or sub-systems may be substituted without departing from the scope hereof. Also, alternate embodiments are envisioned in which a computing device 202 directly accesses one or more servers through a private network rather than via the Internet and a URL.

Computing devices 202 may be equipped with one or more Web browsers to allow them to interact with one or more servers and/or databases via a HyperText Transfer Protocol (“HTTP”). HTTP functions as a request-response protocol in client-server computing. For example, a web browser operating on computing device 202 may execute a client application that allows it to interact with applications executed by the one or more servers. The client application submits HTTP request messages to the one or more servers. The corresponding servers, which provide resources such as HTML files and other data or content, or performs other functions on behalf of the client application, returns a response message to the client application upon request. The response typically contains completion status information about the request as well as the requested content. However, alternate methods of computing device/server communications may be substituted without departing from the scope hereof including those that do not utilize the Internet for communications.

In the exemplary system 200, the databases may include a plurality of databases and/or database tables. As may be appreciated, the databases may be any appropriate database capable of storing data and may be included within or connected to one or more servers similar to those described herein in any appropriate manner without departing from the scope hereof.

It should be understood that the various techniques described herein may be implemented in connection with hardware or software or, as appropriate, with a combination of both. Thus, the methods and apparatus of the presently disclosed subject matter, or certain aspects or portions thereof, may take the form of program code (i.e., instructions, scripts, and the like) embodied in tangible media, such as floppy diskettes, CD-ROMs, hard drives, flash drives, DVDs or any other machine-readable storage medium wherein, when the program code is loaded into and executed by a machine, such as a computer, the machine becomes an apparatus for practicing the presently disclosed subject matter.

In the case of program code execution on programmable computers, the interface unit generally includes a processor, a storage medium readable by the processor (including volatile and non-volatile memory and/or storage elements), at least one input device, and at least one output device. One or more programs may implement or utilize the processes described in connection with the presently disclosed subject matter (e.g., through the use of an application-program interface (“API”), reusable controls, or the like). Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as system 200 or a distributed computing environment. Still further, aspects of the presently disclosed subject matter may be implemented in or across a plurality of processing chips or devices, and storage may similarly be affected across a plurality of devices in system 200. Such devices might include personal computers, network servers, and handheld devices (e.g., cell phones, tablets, smartphones, etc.), for example.

In the exemplary embodiment, one or more servers and its associated databases are programmed to execute a plurality of processes including those discussed in greater detail herein.

Referring now to FIGS. 1A and 1B, depicted is a process 100 for calculating an index value and/or a NAV of one or more components of a fund. For example, process 100 may calculate an index value independent of a fund for informational purposes only. Or, a process such as process 100 may calculate the NAV of one or more shares of a fund. Or, in yet another embodiment, such a process may calculate a first component net asset value (“FC NAV”) of a first separately tradable asset component of a fund or group of funds and a second component net asset value (“SC NAV”) of a second separately tradable asset component of a fund or a group of funds. In such an exemplary embodiment, the fund(s) have two separately tradable asset components, namely, dividend and equity components. In such an embodiment, a process such as process 100 may be utilized to calculate the component NAV of the dividend component, after which the component NAV of the equity component may be calculated by subtracting the dividend component NAV from the total fund(s) NAV or vice versa. However, process 100 may be utilized with funds having varying quantities and/or types of separately tradable asset components or any other separately valuable component without departing from the scope hereof.

In one exemplary embodiment of the present invention, the Index value and/or NAV(s) are calculated and disseminated (i.e., a process such as 100 is executed) every fifteen (15) seconds on each business day from the time of market open to market close, based on the prices on the respective exchanges on which the index components are listed. The most recent prices of all index components are used. Should there be no current price available on a respective exchange, the most recent price or the trading price for the exchange for the preceding trading day may be used in the calculation. However, alternate timing and alternate methods of calculating the price of the Index may be substituted without departing from the scope hereof.

Process 100 begins at 102, at which the current time period and the FC NAV are set to zero. It should be noted that although process 100 is calculating a NAV, it could also calculate an index value that is independent of a fund and/or a single NAV without departing from the scope hereof.

Next, at 104, the index duration is retrieved; for example, from a database such as ETF database 214 as described herein. In the exemplary embodiment of the present invention, the duration of the index was predetermined to be ten (10) years. That is, the index will be calculated based upon a plurality of assets having a cumulative life of ten (10) years from the index creation date, after which the assets shall expire. Process 100 then proceeds to 106, at which the index start date is retrieved. This index start date may be retrieved, for example, from a database such as ETF database 214 as described herein.

Next, at 108, process 100 retrieves the index calculation time period. This calculation time period may be retrieved, for example, from a database such as ETF database 214 as described herein. In the exemplary embodiment of the present invention the calculation time period is one (1) year, however, alternate time periods may be submitted without departing from the scope of the present invention. Further, although the exemplary embodiment includes one calculation time period, alternate embodiments with alternate quantities of calculation time periods are envisioned. For example, an embodiment of the invention is envisioned with two calculation time periods. For example, a first calculation time period could be quarterly for data obtained and/or assets that expire within two (2) years of the current date, and the second calculation time period could be annual for data obtained and/or assets that expire at a time greater than two (2) years from the current date.

Next, at 110, the current time period is set to the final time period of the index. For example, in the depicted embodiment of the present invention in which the index begins on Jan. 1, 2017 and ends on Dec. 31, 2026 and has a one year calculation time period, the final time period of the index is Jan. 1, 2026 through Dec. 31, 2026. In the depicted exemplary embodiment, the index is calculated based upon the values of assets associated with the S&P 500. Also in the depicted embodiment, asset 1 is an S&P 500 Dividend Futures Contracts and asset 2 is a zero coupon bond or other bond. Consequently, in the depicted embodiment, the index value is calculated based upon the values of ten (10) S&P 500 Dividend Futures Contracts (i.e., one contract per year for ten years) and ten (10) zero coupon bonds matched as best as possible to the expiration date of each of the divided futures contracts. Further, in the depicted embodiment, one or more funds also exist that hold the actual future divided contracts and zero coupon bonds (or other such bonds as discussed in greater detail below) and the index value represents the NAV of a share of the fund(s). However, a fund corresponding to the index value is not required to implement the present invention. Also, alternate quantities and types of reference securities and/or related assets may be substituted without departing from the scope hereof.

Process 100 then proceeds to 111, at which one of the URA is selected for analysis. Any manner of selecting a URA for analysis is compatible with the present invention so long as each URA, or the assets associated with the URA, is only analyzed once for each of the relevant time periods during any specific execution of process 100. In the depicted embodiment, only one URA is included and analyzed, namely, S&P 500 Dividend Futures Contracts. However, alternate embodiments are envisioned in which a plurality of URAs are analyzed.

Next, at 112, a price and expiration date are retrieved and recorded for asset 1 for the current time period set at 110. In the depicted embodiment, asset 1 is an S&P 500 Dividend Futures Contract that expires at the end time of the current time period. That is, in the depicted embodiment, this price is the current divided future price a dividend future seller is willing to receive on Dec. 31, 2026 for the S&P 500 Dividend Futures Contract (or at a time as close thereto as possible). Such a price may be retrieved, for example, from a database such as dividend futures price database 222 or via a futures company such as CME Group, Inc. If the latter, such pricing may be retrieved via an automated link to a CME database or the like. The asset 1 dividend futures contract price and expiration date are then saved in a database such as ETF database 214 in relation to the selected URA.

Next, at 114, a price is retrieved for asset 2 for the current time period as set at 110. In the depicted embodiment, asset 2 is a STRIP, which is also known as a U.S. zero coupon bond. That is, in the depicted embodiment, this asset 2 price is the current ask price (expressed as a percentage of par) of a U.S. STRIP maturing on a date that most closely coincides with the expiration date recorded for the dividend futures price at step 112. Such a price may be retrieved, for example, from a database such as U.S. Treasury STRIPS database 230.

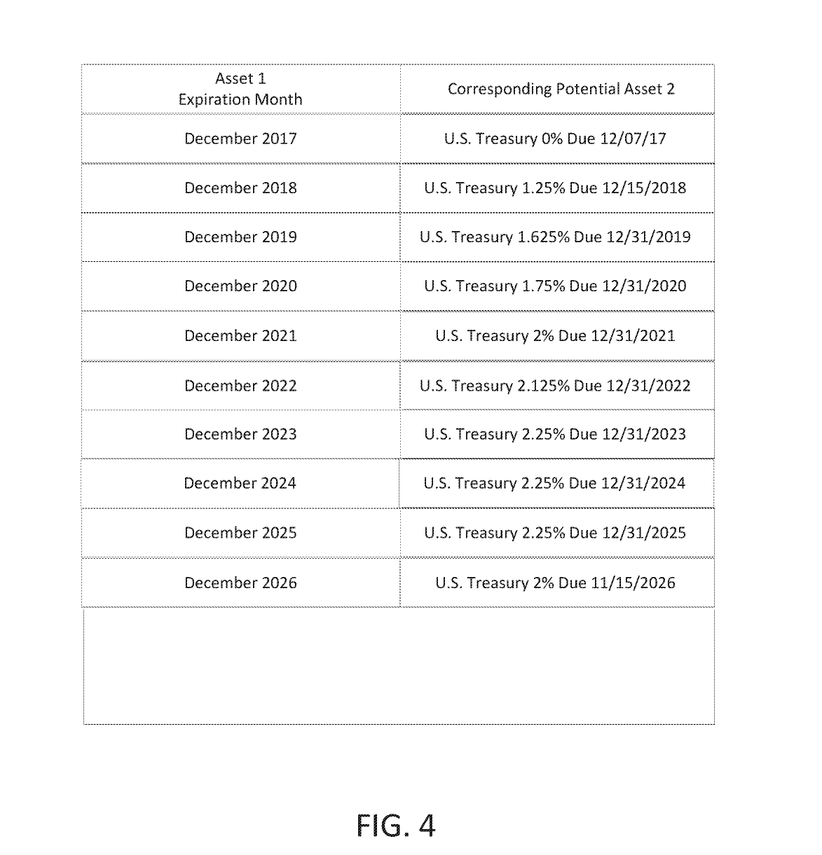

Referring now to FIG. 4, depicted is table 400 of ten (10) of asset 1 and an exemplary, corresponding ten (10) of asset 2. Note that, in this example, asset 2 is a STRIP having varying percentage rates and having expiration dates that coincide with the expiration month of the corresponding asset 1. This listing is an exemplary Initial Treasury Securities list that may be utilized to calculate the FCNAV, SCNAV, or index value for the life of the index unless pricing for one or more of the securities becomes unavailable at which point another security may be substituted (assuming that the security or security time period has not otherwise expired). However, alternate asset 1 and/or asset 2 may be substituted without departing from the scope of the present invention.

In the depicted embodiment of the present invention, the selected treasury securities must meet the following predetermined treasury security criteria: a) minimum amount outstanding of $10 Billion; and b) minimum average daily volume over the preceding 60 trading days of $25 MM or more as reported by a reliable source. However, alternate embodiments of the present invention are envisioned with varying predetermined treasury security criteria.

Referring back to FIG. 1A, process 100 then proceeds to 116, at which a discount factor is determined. In the depicted embodiment, the discount factor is determined by the portion of process 100 shown in FIG. 1B. Turning to FIG. 1B, first, at 128, process 100 queries whether asset 2 is a STRIP/zero coupon bond. If yes, process 100 proceeds to 130, at which the discount factor is set to be the current ask price (expressed as a percentage of par) of the corresponding STRIP. Process 100 then proceeds to 118 (FIG. 1A).

Alternatively, if asset 2 is not a STRIP/zero coupon bond (e.g., if there is no STRIP that fulfills the predetermined treasury security criteria), process 100 proceeds to 132 at which a discount factor (expressed as a percentage of par) will be calculated using the current ask-side Yield to Maturity (“YTM”) of a designated coupon treasury bond with a similar or prior coupon maturity date as the corresponding dividend future expressed on an actual/365 day count basis. This current price may be queried from a database such as fixed income security yield database 234 (FIG. 2).

Process 100 then proceeds to 134, at which the number of days from the settlement date to the maturity date (“T”) is calculated for the designated coupon treasury bond. That is, based upon the current business day, T is the number of bond days from and including the regular settlement date for the coupon treasury bond to but excluding the coupon maturity date for the Treasury bond corresponding to the dividend futures contract calculated on an annual, actual/365 day count basis.

Next, at 136, the discount factor is determined to be:

1/{(1+YTM)/̂^{(T/365)}}.

However, during the time period on or after the maturity date of the STRIP or coupon treasury bond until the expiry of the corresponding dividend futures contract, the discount factor will be equal to 1.00, and this portion of the FC NAV will consist of cash in an amount equal to the dividend index future price for its corresponding dividend futures contract.

Thereafter, process 100 proceeds to 118 (FIG. 1A). At 118, the portion of the FC NAV related to the current time period and the current URA (the first component NAV portion) is determined by multiplying the asset 1 price by the discount factor calculated in the process shown in FIG. 1B. This first component NAV portion is then recorded in a database such as ETF database 214. Then, at 120, the first component NAV portion is added to the current FC NAV sum.

Next, process 100 proceeds to 121, at which it queries whether all of the URAs have been analyzed for the current time period. If no, process 100 proceeds to step 111, at which a new, un-analyzed reference URA is selected. Alternatively, if all of the URAs have been analyzed for the current time period, process 100 proceeds to 122. In the depicted embodiment, the answer to 121 will always be yes since there is only URA (i.e., S&P 500 Dividend Futures Contract) that is being evaluated.

Next, at 122, the current time period is decreased by one. For example, if the current time period prior to 122 is Jan. 1, 2026 through Dec. 31, 2026, the new time period will be Jan. 1, 2025 through Dec. 31, 2025. Then, at 124, process 100 determines whether the current time period end date is prior to the current date. If no, process 100 returns to step 111 and continues to repeat steps 111 through 124 until the point at which the current time period end date is prior to the current date. When this occurs, process 100 proceeds to 139, at which the FCNAV is multiplied by a multiplier M. M is an index multiplier, which is a constant, and is intended to simply reduce the index value or the price of a share of the fund. In the depicted embodiment, this constant is initially set to 1/20. Thereafter, process 100 proceeds to 140, at which the FCNAV is recorded.

Next, at 144, the calculated value of FCNAV may be optionally published. For example, the index pricing may be published via a price marketing service (e.g., Boerse Stuttgart AG), which would then distribute the pricing to all of its affiliated vendors. Each vendor may decide on an individual basis as to whether it will distribute/display the Index via its information systems.

Finally, process 100 proceeds to 146, at which it ends.

In one embodiment of the present invention, the initial value of the index (i.e., the value of FCNAV) is based upon values obtained at the close of the trading day on the start day of the index. However, alternate initial values may be substituted without departing from the scope hereof.

Also, in the depicted embodiment described in FIGS. 1A and 1B, if, during execution of process 100, one or more annual contracts are listed that are not part of the current index composition, these contracts will not be included in the calculation. Also, when any annual dividend futures contract matures, the value of the Index will adjust to reflect the removal of such futures contract from the Index. After expiry of the final dividend futures contract in the Index, the value of the Index will be 0. Also, in the depicted embodiment, the S&P 500 Dividend Futures Contracts initially used to value the index and/or NAV are generally not expected to change. However, during the execution of process 100, and in an embodiment in which asset 2 is a STRIP, an alternate U.S. STRIP may be used to value each futures contract if the current Treasury Security fails to meet certain predetermined treasury security criteria as discussed hereinabove.

That is, in the depicted embodiment, upon the expiration of any dividend futures contract, no additional futures contract (or corresponding US Treasury) will be added to the Index. Therefore, the value of the index is expected to decline in value after each dividend futures expiry. Upon expiration of the last dividend futures contract, the value of the index will be zero. In the event of a change in the calculation of any dividend futures contract, the Index calculation will be adjusted to reflect such change.

If a change is required, such Initial Treasury Security may be substituted with another Treasury Security that meets, or most closely meets, the predetermined treasury security criteria and has a maturity that is nearest to the expiration of the corresponding dividend futures contract. In the event that more than one Treasury Security equally meets the predetermined treasury security criteria and maturity criteria, the Treasury Security with the lowest coupon (i.e. with a duration closest to the corresponding futures contract) will be selected. In the depicted embodiment, the maturity of the selected treasury security must be less than 65 calendar days prior or 35 calendar days after the futures expiry date, however, alternate time periods and alternate methods of selecting and/or substituting treasury securities may be substituted without departing from the scope hereof.

Although the depicted embodiment includes an Index in which the initial assets are intended to remain static, one or more of such assets may be substituted upon the occurrence of an extraordinary event. In such a scenario, the substitution shall be performed after the close of business on the day upon which the extraordinary event occurred. An extraordinary event is any event that results in price unavailability for an asset (e.g., cancellation of a dividend future contract).

In the depicted embodiment, the value of the index and/or FCNAV is rounded to two (2) decimal places, however, alternate roundings may be substituted without departing from the scope hereof.

Although several processes have been disclosed herein as software, it may be appreciated by one of skill in the art that the same processes, functions, etc. may be performed via hardware or a combination of hardware and software. Similarly, although the present invention has been depicted as a hardwired system, these concepts may be applied to wireless systems and hybrid hardwired and wireless systems without departing from the scope of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of calculating an index value and/or a NAV of a component of a fund, the index having a predetermined index duration, comprising the steps of:
separating the index duration into at least one time period;
retrieving at least one first asset price, each of the at least one first asset price associated with one of the underlying reference assets and one of the at least one time period;
retrieving at least one second asset price, each of the at least one second asset price associated with one of the at least one time period;
determining at least one discount factor, each of the at least one discount factor determined from a characteristic of one of the at least one second asset;
determining at least one first component net asset value portion, each of the at least one first component net asset value portion associated with one of the at least one time period, each of the at least one first component net asset value portion determined from the at least one first asset price and the at least one discount factor associated with the at least one time period of the at least one first component net asset value portion; and
determining the first component net asset value as one of the group consisting of:
the at least one first component net asset value portion and a sum of the at least one first component net asset value portion.

2. A method according to claim 1, wherein the first separately tradable asset component is a dividend component.

3. A method according to claim 1, wherein there are two of the at least one separately tradable asset component, the two including a separately tradable dividend component and a separately tradable equity component.

4. A method according to claim 3, wherein a second component net asset value is the value of the equity component and the second component net asset value equals the fund net asset value minus the first component net asset value.

5. A method according to claim 1, wherein the first asset price is a contract price.

6. A method according to claim 5, wherein the at least one contract price is a dividend futures contract price.

7. A method according to claim 1, wherein the second asset price is at least one of the group consisting of a U.S. treasury zero coupon bond price, a U.S. coupon bond, and combinations thereof.

8. A method according to claim 1, wherein the at least one time period includes at least one of the group consisting of an annual time period, a quarterly time period, a monthly time period, a portion of an annual time period, a portion of a quarterly time period, a portion of a monthly time period, and combinations thereof.

9. A method according to claim 1, wherein the predetermined index duration is ten years.

10. A method according to claim 1, wherein the fund is an exchange traded fund.
